(19) United States
(12) Patent Application Publication
(10) Pub. No.: US 2016/0217511 A1
(43) Pub. Date: Jul. 28, 2016

(54) System and methods for facilitating the on-line sale of outfitter adventures

(71) Applicants: Robert Riggs, Aldie, VA (US); Ryan Franklin, Stone Ridge, VA (US)

(72) Inventors: Robert Riggs, Aldie, VA (US); Ryan Franklin, Stone Ridge, VA (US)

(21) Appl. No.: 14/544,582

(22) Filed: Jan. 24, 2015

(51) Int. Cl. G06Q 30/06

(52) U.S. Cl. CPC G06Q 30/0601

(57) ABSTRACT

Systems and methods are provided for selecting and purchasing adventure packages on-line. The system includes a web site computer including a settlement module and a database configured to store indicia of a plurality of adventure packages from a plurality of outfitters, respectively; a user computer configured to interact with the web site computer through a network; and a settlement computer configured to interact with the web site computer through the network. The settlement module is configured to consummate the sale of a selected adventure package to the user in real time using the settlement computer as an intermediary. The indicia includes: i) an activity type comprising at least one of the attributes: hunting, fishing, and an interactive physical action; and ii) an attribute comprising at least one of: a specie, a license requirement, and a human physical requirement associated with the interactive physical action.

### TECHNICAL FIELD

The present invention generally relates to systems and methods for facilitating the on-line sale of adventure packages offered by outfitters to hunting, fishing, and outdoor enthusiasts. More particularly, the following discussion relates to an e-commerce platform for matching outfitters with consumers seeking adventures, and for consummating the sale thereof.

### BACKGROUND

Airlines, hotels, rental car agencies, and cruise ship operators simultaneously market their products and services on a plurality of travel and leisure web sites. Sites such as www.travelandleisure.com, www.kayak.com, www.hotels.com, www.travelocity.com, www.orbitz.com, and www.expedia.com allow consumers to search, browse and compare prices and amenities, and to purchase travel products using a single, integrated e-commerce platform. When these parallel marketing channels result in “collisions” or overbooking, providers may compensate their customers for any resulting inconvenience without compromising the overall customer experience. Consequently, e-commerce web sites may confidently consummate a sale in real time, without having to specifically verify the availability of a particular hotel room or airline seat as a predicate to the sale.

More particularly, the highly commoditized nature of conventional travel products renders them largely interchangeable, such that consumers are generally willing to substitute an overbooked or otherwise unavailable product for a similar one, particularly if incented to do so with an upgrade, travel voucher, or future discount. In this context, substantially similar commodities may include, for example: ocean view rooms on the ninth versus the tenth floor of the same hotel; a non-stop departure from Phoenix to Orlando at 3:45 p.m. versus 2:30 p.m.; a mid-size Chevrolet versus a mid-size Toyota, and so on. Conversely, consumers are less willing to substitute highly customized (less commoditized) travel products, such as accepting a fly-fishing adventure in Mississippi because a preferred elk hunting adventure in Idaho was double booked.

The highly commoditized characteristics of conventional travel and leisure products also facilitates the seamless integration of additional providers and products offerings into existing on-line marketplaces. For example, because the hotel room product space is mature and finite, a hotel web site can easily add a new provider using a “static” template to be populated with data items for each of the various attributes associated with a hotel room. In this context, a “static” template implies a fixed set of known attributes such as location, cost, available dates, amenities, and the like. In addition, the various items associated with each attribute also typically comprise a closed group (e.g., the attribute “swimming pool” may comprise the closed group of options including “yes” and “no”).

At the same time, the use of static templates necessarily limits a web site's ability to add products, which are not contemplated by the static template. For example, although consumers seeking a nightly room rental may wish to consider renting a room in a private home (as opposed to a hotel chain), presently known hotel web sites do not offer rooms located in private homes, primarily because the static template used to populate hotel room databases does not contemplate private homes as a product category. Indeed, web sites such as www.airbnb.com have sprung up precisely because existing hotel web sites could not easily fit private homes into their static database populating templates.

For these same reasons, highly specialized travel and leisure products such as hunting, fishing, white water rafting, do not fit well within existing on-line vacation marketplaces. That is, existing static templates do not contemplate highly customized adventures. As a result, niche websites such as www.huntingoutfitters.com and www.guidefitter.com have been created to target consumers of interactive adventure vacations. However, because these customized adventures cannot be easily substituted, it is imperative that collisions and double bookings be avoided. Hence, consumers are limited to browsing—and not purchasing—adventures on the marketplace website. Significantly, consumers must navigate to the outfitter's web site in order to actually purchase the adventure.

Presently known hotel-type travel and leisure web sites do not conveniently scale to accommodate adventure vacation products, nor do they allow a consumer to purchase the adventure without having to log onto a separate outfitter's website. Systems and methods are thus needed which overcome these limitations. Various desirable features and characteristics will also become apparent from the subsequent detailed description and the appended claims, taken in conjunction with the accompanying drawings and this background section.

### BRIEF SUMMARY

Various embodiments relate to systems, methods, on-line marketplaces (web sites), and e-commerce platforms for enhancing the user experience when shopping for and purchasing adventures of the type including hunting, fishing, photo safari, white water rafting, zip line expeditions, and other interactive vacation activities. In various embodiments, an online marketplace matches adventure enthusiasts with adventure outfitters, allowing the consumer to search, browse, select, and purchase an adventure using a single, integrated portal. For example, an exemplary workflow associated with consummating a purchase requires the site to first verify with the outfitter that the requested adventure is available before completing the purchase transaction. In this way, collisions and double booking may be avoided, particularly inasmuch as highly customizable adventures may not be easily substituted.

Other embodiments allow a user to interrogate a product database populated with adventures from a plurality of outfitters. Alternatively, a user may search profile pages associated with registered users, outfitters, or both. In yet a further alternative, users may search available adventures by navigating through hotspots equipped with cameras, which feed photos, video, audio, and analytics from adventure sites (e.g., hunting trails, ski runs, fishing holes, and the like) to the web platform. Other embodiments provide dynamic templates which facilitate the interactive addition of adventure products into the inventory database, even if those products were not previously contemplated by the web site (i.e., a new product category).

Other embodiments provide a profile page for each registered user and each outfitter, where various attributes of the profile pages are searchable. An outfitter's profile page may include, inter alia, the details of all adventures available from that outfitter, as well as hotspots associated with those adventures. A user's profile page may include, inter alia, a virtual game room displaying photos and/or videos of game hunted or harvested by a user, analogous to a taxidermy trophy room.

Other embodiments provide a timeshare feature whereby outfitters can contribute adventure packages to a pool in exchange for points which may be used to “purchase” adventures from the pool.

Various other embodiments, aspects and features are described in more detail below.

### BRIEF DESCRIPTION OF THE DRAWING FIGURES

Exemplary embodiments will hereinafter be described in conjunction with the following drawing figures, wherein like numerals denote like elements, and:

FIG. 1 is a schematic block diagram of an exemplary system for interconnecting consumers and outfitters on an e-commerce platform including an adventure inventory database accordance with various embodiments;

FIG. 2 is a screenshot of an exemplary home page of an outfitter adventure marketplace in accordance with various embodiments;

FIG. 3 is a screenshot of an exemplary adventure search results page in accordance with various embodiments;

FIG. 4 is a screenshot of an exemplary purchase wizard page for a selected adventure in accordance with various embodiments;

FIG. 5 is a schematic screenshot of an exemplary wizard for implementing a dynamic template for adding new adventures in accordance with various embodiments;

FIG. 6 is a flow chart of an exemplary process for adding new adventures to the adventure database of FIG. 1 using the wizard of FIG. 5 in accordance with various embodiments; and

FIG. 7 is process flow diagram of an exemplary work flow for consummating an adventure purchase transaction in accordance with various embodiments.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

Various embodiments of the subject outfitter e-commerce platform may be designed and engineered in the tradition of high performance, feature richness, elegant simplicity, and high reliability consistent with the needs of a demanding adventure customer base. Various embodiments address key shortcomings associated with presently known outfitter adventure marketplaces. In particular, the present invention provides a wizard for use by an outfitter for dynamically adding new adventures to the marketplace database, even if the added adventures comprise categories and/or attributes not been previously contemplated by the marketplace. In addition, the e-commerce platform allows a consumer to search the adventure database, browse search results, compare attributes, prices, and the like, and consummate a purchase transaction without having to leave the web site.

The present invention further provides user profile pages and outfitter profile pages to facilitate interaction among users and outfitters. In an embodiment, a user profile page may include a virtual game room where a user may showcase game hunted or harvested by that user. An outfitter profile page and, indeed, an adventure listing, may include one or more hotspots; that is, a link to a trail camera or other device which feeds real time and/or analytics information regarding an adventure site to the portal for real time viewing by a user to assist in selecting an adventure,

The present invention further provides a timeshare feature whereby outfitters (and users) may contribute adventures and/or other resources to a shared pool in exchange for reward points, which may be applied towards the purchase of adventures and/or other amenities.

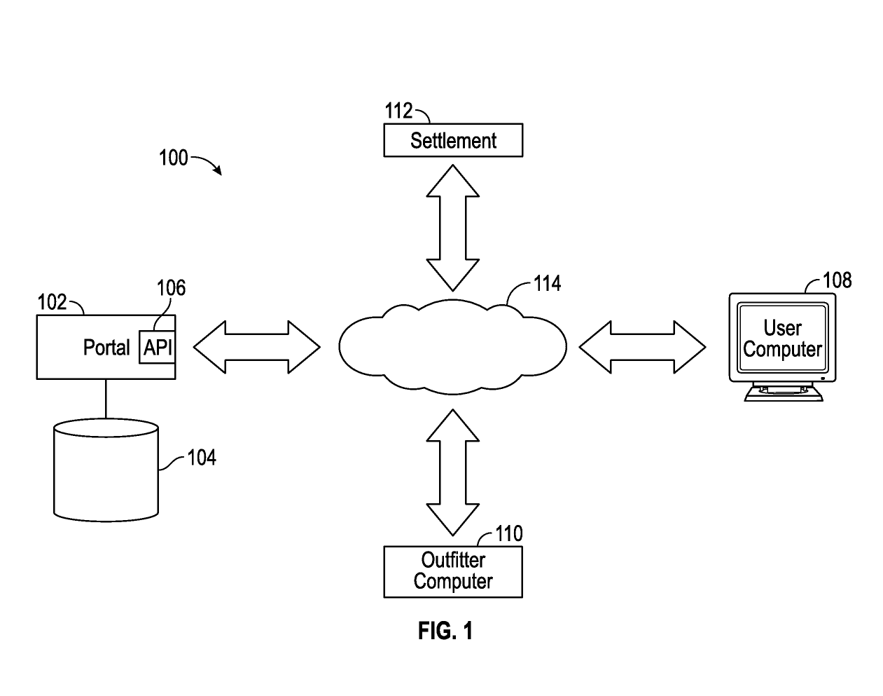

Turning now to the drawings and with particular reference to FIG. 1, system 100 includes a portal computer 102 for facilitating interaction between consumers and an adventure inventory database 104 and for facilitating real time purchase transactions. The portal computer 102 includes one or more application program interfaces (APIs) 106 for interfacing with other logical modules including, for example, a settlement computer 112 configured to processing financial transactions using tools available from www.stripe.com, www.bigcommerce.com, or the like).

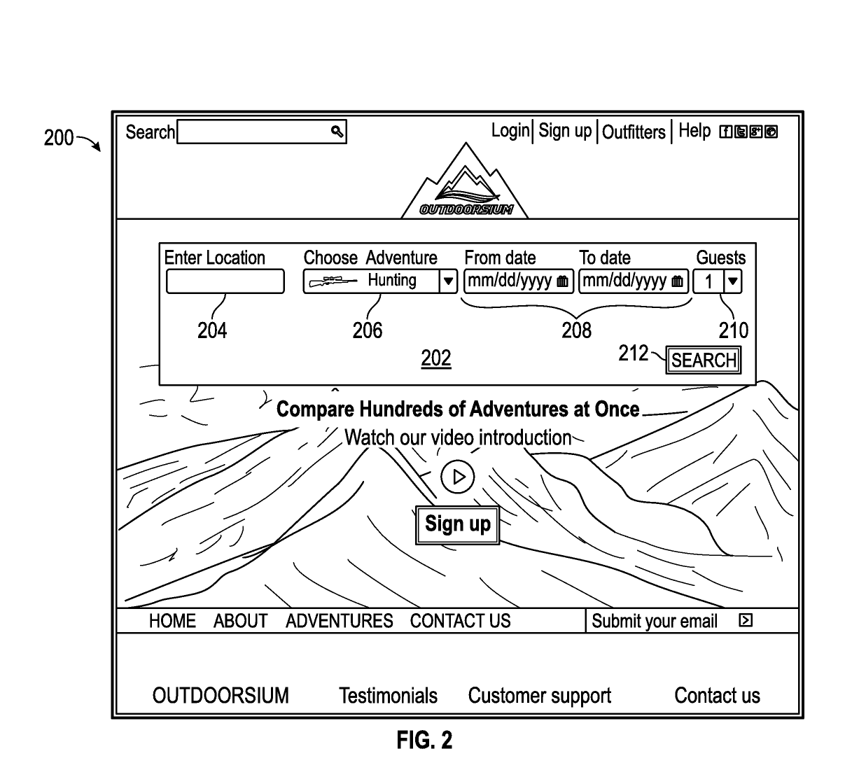

With continued reference to FIG. 1, the system 100 further includes a user computer 108 and an outfitter computer 110 interconnected to the foregoing nodes through a network 114 such as the internet. The manner in which the computing modules shown in FIG. 1 interact will now be described in conjunction with FIGS. 2-8.

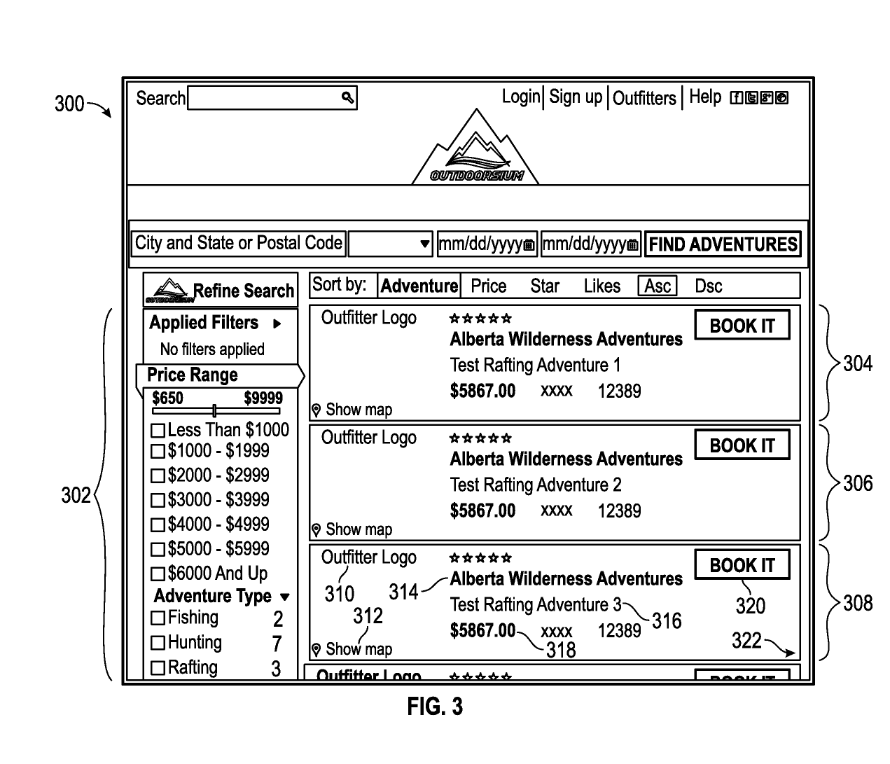

FIG. 2 is a screenshot of an exemplary adventure marketplace home page 200 available at www.outdoorsium.com. The home page 200 includes any number of tabs, panels, virtual buttons, and links for performing any number of desired functions and features, including a search panel having a location field 204, an activity field 206, a date field 208, a guest field 210, and a search button 212 for executing a configured inquiry. Each field may include drop down menus or may allow manual text entry. Once a search is performed, the user may review the search results, as described in greater detail below in conjunction with FIG. 3.

FIG. 3 is a screenshot of an exemplary results page 300 illustrating various filters and other navigation and/or browsing features 302, and a plurality of individual search result panels 304, 306, 308 presented in the form of a conventional vertically scrollable feed, a static page, or any other desired format. Each search result panel corresponds to an adventure retrieved from the database 104, and includes a logo 310 associated with the outfitter offering the adventure, a link 312 to a map illustrating the location of the adventure, a name field 314 of the offering outfitter, a title field 316 indicating the name of the adventure, a price field 318, a booking link 320, and a detail virtual button 322. Those skilled in the art will appreciate that the illustrated embodiments retain the look and feel of conventional travel and leisure web sites to a large extent, thereby leveraging users' experience with presently known on-line shopping paradigms.

With continued reference to FIG. 3, selecting the detail or a similar button 322 causes the computer 102 to display on the computer 108 additional detail associated with the outfitter and the selected adventure. In an embodiment, the additional detail may include a hotspot link which provides real time information and data from an outfitter adventure camera located at the site of the adventure, such as cameras available at www.spypoint.com. More particularly, the camera may provide information such as pictures and video of game, species type, time and date of photo/video, moon phase, temperature, barometric pressure, and various weather conditions (rain, fog, snow, sun, cloud cover, etc.). in addition, the camera could provide analytics such as number of sightings for various species over predetermined or configurable time periods.

More particularly, the analytics provided by the remote game camera may include trending information indicating an increase or decrease in nearby populations of species of interest, size of flocks, herds, and the like, to assist users in selecting among various adventures uncovered during the search. Moreover, by providing a real time and/or historic photographic and/or video fee, the user may become intimately familiar with the adventure venue, thereby facilitating a more informed selection.

The information provided by various cameras may be stored in the database 104, aggregated, and provided to outfitters to assist them in competitively pricing their adventures based on game movement, seasonality of available species, game size, and the like. In addition, predictive analytic functionality could be embedded along with historical booking capacity, trip occupancy ratios, price, page views, and other analytics to assist users in selecting adventures and to assist outfitters in pricing them.

From the end user's perspective, all or a subset of the hotspots may be assembled onto an interactive map, such that a user can apply filters to narrow the list of displayed hotspots. Such filters may include, without limitation, adventure type (e.g., hunting, fishing, rafting, hang gliding, zip lines, sky diving, camping, hiking trails, repelling), game species (e.g., elk, deer, bighorn sheep, geese), class (based on animal size), time of day, date range, geographic region, terrain type, and so on.

In accordance with various embodiments, hotspots may be displayed on the map in any desired manner including pins. Rolling or hovering over a hotspot may cause pictures, data, or a drop down menu of attributes associated with the hotspot to be displayed. In addition, a “Trip Recommendations” feature permits the marketplace to make adventure trip recommendations to users based on various meta-data, trending data from the hotspot, end-user interaction within the site, promotional information, and the like.

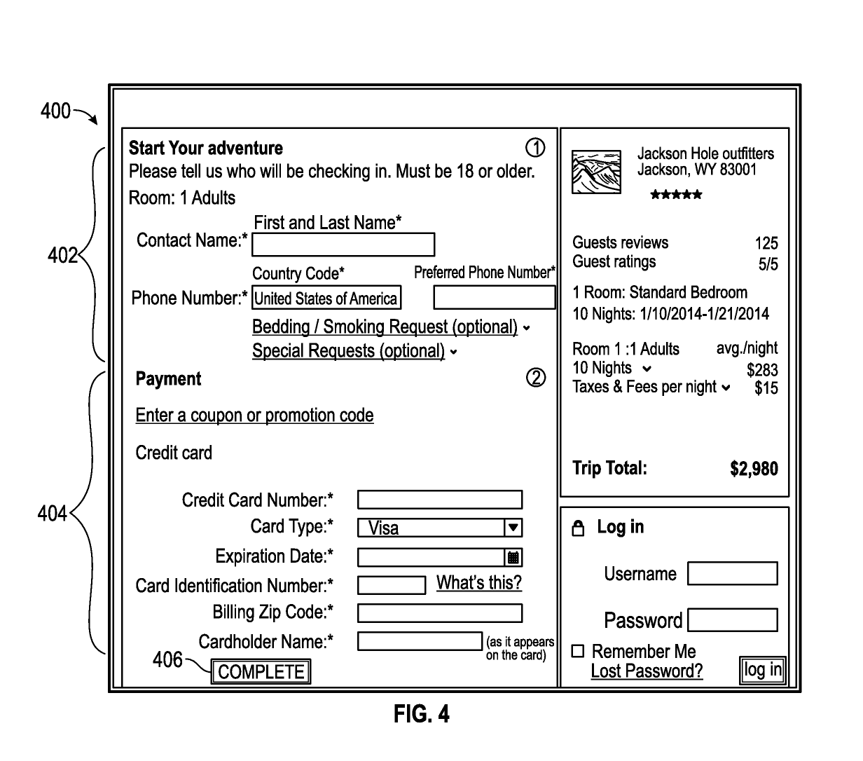

Referring now to FIG. 4 and with momentary reference to FIG. 3, selecting the “BOOK IT” icon 320 for a particular adventure reveals a purchase wizard 400, which allows the user to purchase the adventure in real time without having to leave the marketplace portal. In contrast, in order to purchase an adventure using presently known adventure marketplaces, the user is required to leave the marketplace and contact the outfitter directly in order to purchase an adventure.

With continued reference to FIG. 4, the purchase wizard 400 includes an identification panel 402 for identifying the person(s) participating in the adventure, a payment panel 404 for credit card or other payment information, a confirmation panel (not shown) for providing confirmation contact information (e.g., email address), and a completion button 406 for completing the transaction. Once the user clicks the complete button 406, the transaction is completed, paid for, and booked. The manner in which the system 100 coordinates payment and verification with the outfitter will be described in greater detail below in conjunction with FIG. 8.

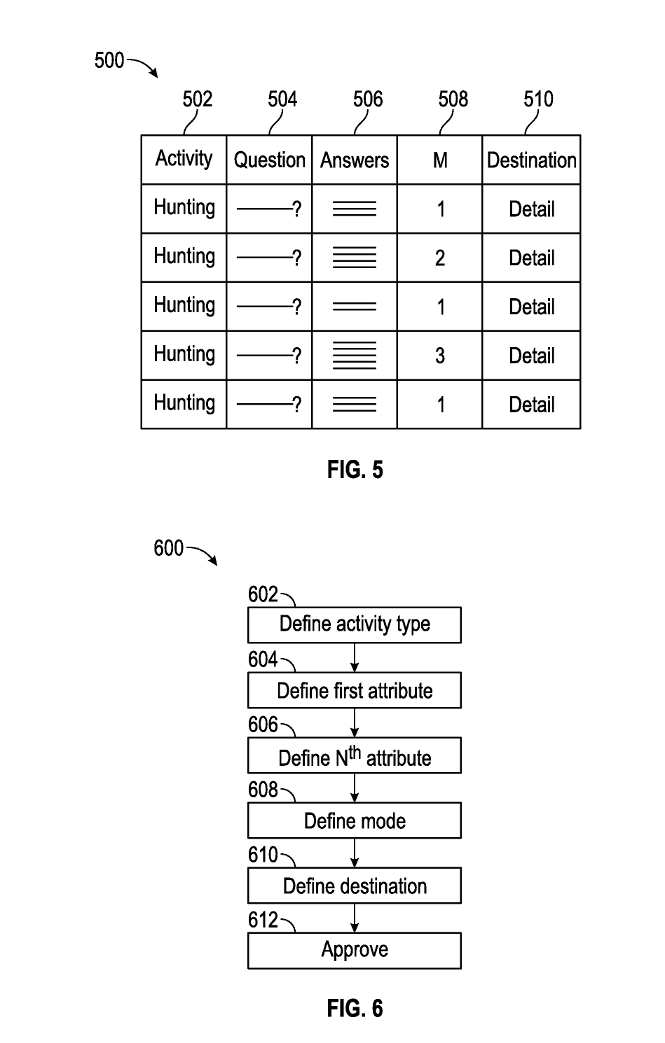

Turning now to FIG. 5, an exemplary wizard 500 assists outfitters in adding new adventures to the database 104 using a dynamic template, as opposed to the static templates used by presently known travel web sites. More particularly, the wizard 500 suitably comprises an interactive graphical user interface (GUI) tool, which successively prompts the outfitter to enter information pertaining to an adventure which the outfitter desires to add to the database. In an embodiment, the GUI includes an activity designation 502 (e.g., hunting, fishing, white water rafting, etc.), and a series of questions 504 of the type typically asked by an end user and intended to solicit the information needed to populated various fields associated with an adventure as described above in connection with FIG. 3.

The GUI also includes proposed answers 506 for each question, a mode 508, and a destination field 510. In an embodiment, the mode 508 may indicate whether a single answer is to be selected by the outfitter from the answer field 506 (mode 1), multiple answers are to be selected (mode 2), or multiple answers plus manually entered text are to be employed (mode 3). The destination field 510 determines where the associated information is to be displayed such as, for example, in one of the various tabs or panels discussed above in connection with FIG. 3.

With continued reference to FIG. 5, for each adventure sought to be added to the database, the wizard 500 may be configured to prompt the outfitter to accept a proposed activity designation 502 “as is”, edit the proposed activity designation, delete the proposed activity designation, or add an entirely new activity designation. The wizard 500 may be further configured to prompt the outfitter, for each activity, to accept a proposed question “as is”, edit the proposed question, delete the proposed question, or add one or more new questions associated with the then current activity.

The wizard may then prompt the outfitter to accept one or more of the proposed answers “as is”, edit the proposed answers, or add one or more new answers for the newly configured questions associated with the then current activity. In this way, new adventures and their attributes may be seamlessly added to the database, regardless of whether they correspond to existing activity types or entirely new activities.

FIG. 6 is a flow chart of an exemplary process 600 for adding new adventures to the adventure database using the wizard of FIG. 5 in accordance with various embodiments. More particularly, the process 600 includes prompting the outfitter to define a data object corresponding to activity type (e.g., hunting) for a particular adventure (Task 602). If the activity type is included in the available activity types 502 (FIG. 5), the outfitter may select that type. If, on the other hand, the activity type is not included in the activity list 502, the outfitter may manually add it to the database using the wizard. For example, if the activity is of a new type such as hang gliding which is not currently contemplated by the wizard, the outfitter may nonetheless add a new hang gliding adventure to the database by simply defining a new activity type and augmenting the capability of the wizard going forward. To this extent, the wizard can be said to embody a learning algorithm.

Having defined the activity type for the then current adventure, the process 600 then prompts the outfitter, for example using the questions shown in FIG. 5, to define a first attribute associated with the adventure (Task 604). For example, one attribute may relate to the type of game (species) being hunted, or particular types of hang gliding maneuvers to be experienced during the adventure. If the specie/maneuver exists in the proposed answer 506, the outfitter may select it. If, on the other hand, the specie/maneuver is not included in the proposed answers, the outfitter may manually add it to the database using the wizard. The process continues to prompt the outfitter to define attributes until the Nth (final) attribute is defined (Task 606).

With continued reference to FIG. 6, the process 600 may also prompt the outfitter to define the mode 508 for each question 504 and associated answer(s) 506 (Task 608). Similarly, the process 600 prompts the outfitter to define the destination 510 in which the information is to be displayed (Task 610). Finally, the process prompts the outfitter to confirm the accuracy of the information (Task 612), whereupon the new adventure may be added to the database 104.

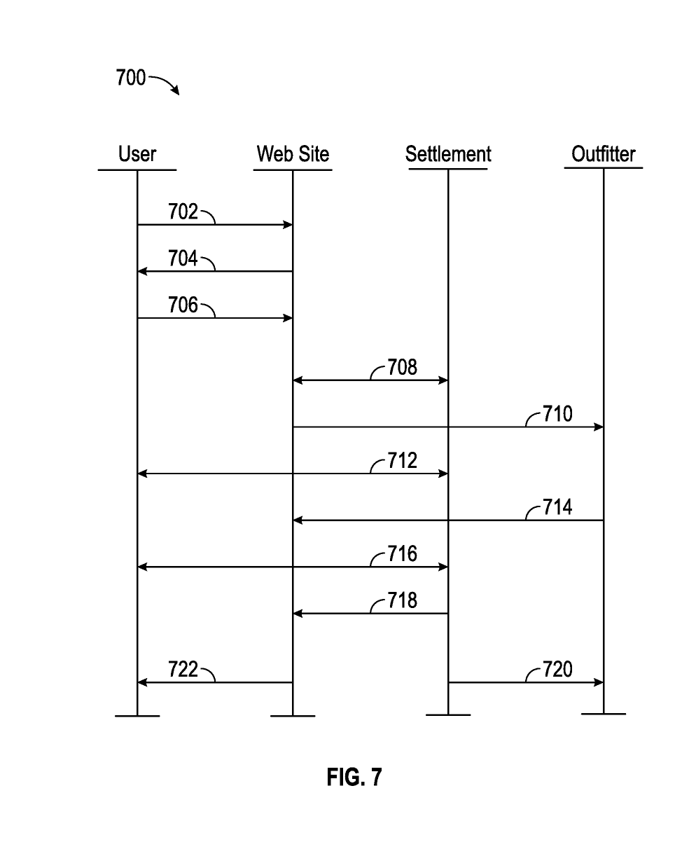

FIG. 7 is a process flow diagram depicting an exemplary work flow 700 for consummating an adventure purchase transaction. In various embodiments, the end user interrogates the database 104 using any suitable search metrics and/or filters (function 702), whereupon the adventure marketplace (web site) returns the search results to the end user (function 704), where the search results typically comprising a plurality of candidate adventures available for purchase by the end user. Upon selecting an adventure to purchase, the end user clicks the “BOOK IT” button 320 (FIG. 3), causing a booking request to be sent to the web site and a (function 706). In response, the website invokes API 106 (FIG. 1) and establishes a payment session with the settlement computer 112 (FIG. 1) (function 708). The web site also contacts the outfitter to verify that the selected adventure is still available as a predicate to completing the transaction (function 710).

With continued reference to FIG. 7, the end user and the web site interactively complete a payment wizard such as that shown in FIG. 4 (function 712), pursuant to which the settlement authority places a hold on the end user's credit instrument pending verification by the outfitter that the selected adventure is available for purchase. Upon receiving confirmation from the outfitter that the adventure is still available (function 714), the settlement authority debits the end user's credit instrument (function 716). The settlement authority then remits a portion of the proceeds to the web site (function 718), and remits the remainder of the proceeds to the outfitter (function 720), whereupon the website confirms completion of the transaction with the end user (function 722).

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

A system is thus provided for selecting and purchasing adventure packages on-line. The system includes a web site computer including a settlement module and a database configured to store indicia of a plurality of adventure packages from a plurality of outfitters, respectively; a user computer configured to interact with the web site computer through a network; and a settlement computer configured to interact with the web site computer through the network. The settlement module is configured to consummate the sale of a selected adventure package to the user in real time using the settlement computer as an intermediary. The indicia includes: i) an activity type comprising at least one of the attributes: hunting, fishing, and an interactive physical action; and ii) an attribute comprising at least one of: a specie, a license requirement, and a human physical requirement associated with the interactive physical action.

In an embodiment, the network comprises the internet.

In an embodiment, the hunting attribute comprises one of bear, deer, elk, big game, duck, geese, turkey, bighorn sheep.

In an embodiment, the fishing attribute comprises one of fly-fishing, deep sea fishing, bass fishing, trout fishing, fresh water fishing, and salt water fishing.

In an embodiment, the interactive physical action comprises one of white water rafting, snow skiing, water skiing, hang gliding, sky diving, zip line adventure, kayaking, repelling, hiking, camping, triathlon, and iron man competition.

In an embodiment, the settlement module comprises an application programming interface (API).

In an embodiment, the web site computer includes a processor configured to execute dynamic template wizard, and further wherein the database is configured to be dynamically updatable to include additional adventure packages using the dynamic template wizard.

In an embodiment, the indicia further includes a hotspot link.

In an embodiment, the web site computer is configured to selectively enable the hotspot link to thereby display on the end user computer at least one of: i) photo, video, and audio associated with an adventure package; and ii) analytics associated with the adventure package.

A wizard executable by a processor associated with a web site computer is provided for adding an adventure package to a database is by: prompting an outfitter to define an activity type; prompting an outfitter to define a plurality of attributes associated with the activity type; defining a mode associated with at least one of the attributes; and defining a destination for at least one of the activity types; wherein the adventure package comprises one of hunting, fishing, and an interactive physical action; and wherein one the attributes comprises at least one of a specie, a license requirement, and a human physical requirement associated with the interactive physical action.

In an embodiment, the wizard is further configured to: present the outfitter with a graphical user interface comprising an activity type field, a question field, an answer field, a mode field, and a destination field.

In an embodiment, the wizard is further configured to prompt the outfitter to accept, delete, modify or replace a respective one of each of a plurality of questions.

In an embodiment one of the attributes comprises a hotspot configured to display on an end user computer at least one of: i) photo, video, and audio associated with an adventure package; and ii) analytics associated with the adventure package.

A method of facilitating the selection and purchase of an adventure package on an outfitter marketplace web site computer is also provided. The method includes interrogating, by an end user computer, a database associated with the web site computer; transmitting search results from the web site computer to the end user computer, the search results comprising a plurality of candidate adventure packages available for purchase by the end user computer; selecting, by the end user computer, a particular one of the candidate adventures; transmitting, from the end user computer to the web site computer, a booking request for the selected adventure package; establishing a payment session between a settlement computer and the web site computer; contacting, by the web site computer, the outfitter to verify that the selected adventure package is still available; placing a hold on a credit instrument associated with p the end user computer ending verification by the outfitter that the selected adventure package is available; and debiting the end user's credit instrument.

In an embodiment, the method further comprises: remitting a portion of the debited proceeds to the web site computer; and remitting a remainder of the proceeds to the outfitter.

What is claimed:

1. A system for selecting and purchasing adventure packages on-line, comprising:
a web site computer including a settlement module and a database configured to store indicia of a plurality of adventure packages from a plurality of outfitters, respectively;
a user computer configured to interact with the web site computer through a network; and
a settlement computer configured to interact with the web site computer through the network;
wherein the settlement module is configured to consummate the sale of a selected adventure package to the user in real time using the settlement computer as an intermediary; and
wherein the indicia includes:
i) an activity type comprising at least one of the attributes: hunting, fishing, and an interactive physical action; and
ii) an attribute comprising at least one of: a specie, a license requirement, and a human physical requirement associated with the interactive physical action.

2. The system of claim 1, wherein the network comprises the internet.

3. The system of claim 1, wherein the hunting attribute comprises one of bear, deer, elk, big game, duck, geese, turkey, bighorn sheep.

4. The system of claim 1, wherein the fishing attribute comprises one of fly-fishing, deep sea fishing, bass fishing, trout fishing, fresh water fishing, and salt water fishing.

5. The system of claim 1, wherein the interactive physical action comprises one of white water rafting, snow skiing, water skiing, hang gliding, sky diving, zip line adventure, kayaking, repelling, hiking, camping, triathlon, and iron man competition.

6. The system of claim 1, wherein the settlement module comprises an application programming interface (API).

7. The system of claim 1, wherein the web site computer includes a processor configured to execute dynamic template wizard, and further wherein the database is configured to be dynamically updatable to include additional adventure packages using the dynamic template wizard.

8. The system of claim 1, wherein the indicia further includes a hotspot link.

9. The system of claim 8, wherein the web site computer is configured to selectively enable the hotspot link to thereby display on the end user computer at least one of: i) photo, video, and audio associated with an adventure package; and ii) analytics associated with the adventure package.

10. A wizard executable by a processor associated with a web site computer for adding an adventure package to a database by:
prompting an outfitter to define an activity type;
prompting an outfitter to define a plurality of attributes associated with the activity type;
defining a mode associated with at least one of the attributes; and
defining a destination for at least one of the activity types;
wherein the adventure package comprises one of hunting, fishing, and an interactive physical action;
wherein one the attributes comprises at least one of a specie, a license requirement, and a human physical requirement associated with the interactive physical action.

11. The wizard of claim 10, further configured to:
present the outfitter with a graphical user interface comprising an activity type field, a question field, an answer field, a mode field, and a destination field.

12. The wizard of claim 10, further configured to prompt the outfitter to accept, delete, modify or replace a respective one of each of a plurality of questions.

13. The wizard of claim 10, wherein one of the attributes comprises a hotspot configured to display on an end user computer at least one of: i) photo, video, and audio associated with an adventure package; and ii) analytics associated with the adventure package.

14. A method of facilitating the selection and purchase of an adventure package on an outfitter marketplace web site computer, comprising:
interrogating, by an end user computer, a database associated with the web site computer;
transmitting search results from the web site computer to the end user computer, the search results comprising a plurality of candidate adventure packages available for purchase by the end user computer;
selecting, by the end user computer, a particular one of the candidate adventures;
transmitting, from the end user computer to the web site computer, a booking request for the selected adventure package;
establishing a payment session between a settlement computer and the web site computer;
contacting, by the web site computer, the outfitter to verify that the selected adventure package is still available;
placing a hold on a credit instrument associated with p the end user computer ending verification by the outfitter that the selected adventure package is available;
debiting the end user's credit instrument.

15. The method of claim 14, further comprising:
remitting a portion of the debited proceeds to the web site computer; and
remitting a remainder of the proceeds to the outfitter.
